(19) United States
(12) Patent Application Publication
(10) Pub. No.: US 2025/0153597 A1
(43) Pub. Date: May 15, 2025

(54) APPARATUS AND METHOD FOR RECOMMENDING A CHARGING STATION FOR AN ELECTRIC VEHICLE

(71) Applicants: HYUNDAI MOTOR COMPANY, SEOUL (KR); KIA CORPORATION, SEOUL (KR)

(72) Inventors: Dong Hyun Kang, Hwaseong-si (KR); Chi Hwan Kim, Hwaseong-si (KR)

(73) Assignees: HYUNDAI MOTOR COMPANY, SEOUL (KR); KIA CORPORATION, SEOUL (KR)

(21) Appl. No.: 18/894,277

(22) Filed: Sep. 24, 2024

(30) Foreign Application Priority Data
Nov. 9, 2023 (KR) 10-2023-0154835

(51) Int. Cl. B60L 53/66

(52) U.S. Cl. CPC B60L 53/66; B60L 2240/72

(57) ABSTRACT

A charging station recommending apparatus for an electric vehicle includes a communication device configured to communicate with vehicles and charging stations, and a processor configured to determine an average stay time for each position of the vehicles by using vehicle driving information collected from the vehicles, and in response to a case where vehicle information is received from a target vehicle to recommend a charging station, to recommend a charging station near a destination to the target vehicle based on a time it takes for the target vehicle to reach the destination and charge to a target charging amount, and the average stay time for each position.

### CROSS REFERENCE TO RELATED APPLICATIONS

This application claims priority to and the benefit of Korean Patent Application No. 10-2023-0154835, filed in the Korean Intellectual Property Office on Nov. 9, 2023, the entire contents of which are incorporated herein by reference.

### BACKGROUND

### (a) Field

The present disclosure relates to a charging station recommending apparatus and method for an electric vehicle, and more particularly, to a technique for automatically recommending a charging station for an electric vehicle based on vehicle driving information.

### (b) Description of the Related Art

Unlike regular internal combustion engine vehicles, electric vehicles include a battery, an electric motor, an inverter, a converter, and a battery management system (BMS), and a rechargeable secondary battery is used for the battery.

A prerequisite for spreading electric vehicles is establishing a charging infrastructure, and countries around the world are deriving models for charging infrastructure composition and services and conducting demonstration projects.

Meanwhile, electric vehicle (EV) charging stations are disclosing an operation status of chargers (Charging Point (CP)) to attract customers.

Conventionally, customers refer to information disclosed by a charging station operator and directly find available charging stations during their schedule and charge their vehicles. However, unlike typical cars that use oil as fuel, electric vehicles take a relatively long time to charge their batteries.

Accordingly, in a case where many electric vehicles are charging or waiting to be charged at a specific charging station, electric vehicles visiting a charging station may wait a long time to charge their batteries or may find it difficult to charge as desired.

Thus, electric vehicle drivers must determine a length of time they will stay at their destinations and a charging time to find an appropriate charging station positioned near their destinations. That is, the electric vehicle drivers manually determine an expected time to stay at their destinations, search for charging stations positioned near their destinations, check charger speeds and charger types of the charging stations, and then select a charging station, and go directly to the selected charging station to charge, which requires troublesome effort from the drivers.

### SUMMARY

Exemplary embodiments of the present disclosure attempt to provide a charging station recommending apparatus and method for an electric vehicle, configured for increasing user convenience by recommending a charging station that suits a situation of a user among charging stations near a destination based on an average time the vehicle stays for each point of interest (POI) of surrounding vehicles and vehicle information of a target vehicle for charging station recommendation.

Exemplary embodiments of the present disclosure also attempt to provide a charging station recommending apparatus and method for an electric vehicle, configured for collecting vehicle driving information (e.g., destination information, ignition on/off information, etc.) from vehicles, determining an average stay time of vehicles for each POI, and storing and managing them.

The technical objects of the present disclosure are not limited to the objects mentioned above, and other technical objects not mentioned may be clearly understood by those skilled in the art from the description of the claims.

An exemplary embodiment of the present disclosure provides a charging station recommending apparatus for an electric vehicle, including a communication device configured to communicate with vehicles and charging stations, and a processor configured to determine an average stay time for each position of the vehicles by using vehicle driving information collected from the vehicles, and in response to a case where vehicle information is received from a target vehicle to recommend a charging station, to recommend a charging station near a destination to the target vehicle based on a time it takes for the target vehicle to reach the destination and charge to a target charging amount, and the average stay time for each position.

In an exemplary embodiment of the present disclosure, the vehicle driving information may include destination information and ignition-on/off time information.

In an exemplary embodiment of the present disclosure, the vehicle information may include destination information, SOC (stage of charge) information of the vehicle, and target charging amount information.

In an exemplary embodiment of the present disclosure, the vehicle information may further include charging station usage history information of the vehicle, or charging station preference information of a user of the vehicle.

In an exemplary embodiment of the present disclosure, the processor may be configured to determine that it is the target vehicle in response to a case where a SOC at a time the vehicle arrives at the destination is smaller than a predetermined reference value.

In an exemplary embodiment of the present disclosure, the processor may be configured to determine a charging time using a difference between a SOC at the time the target vehicle reaches the destination and a predetermined target charging amount, and a charging speed level of the charging station.

In an exemplary embodiment of the present disclosure, the processor may be configured to use an average stay time at a destination of the target vehicle among average stay times for each position of the vehicles and the determined charging time, and to recommend a charging station suitable for the charging time among charging stations near the destination.

In an exemplary embodiment of the present disclosure, the processor may be configured to recommend one of the charging stations near the destination by using at least one of the following an average stay time of the vehicles at each position, a charging time required to charge the target vehicle to the target charging amount, charging station information received from charging stations, charging station preference information, charging station usage history information, or a combination thereof.

In an exemplary embodiment of the present disclosure, the processor may be configured to determine the average stay time for each position using a difference between an ignition-off time of a previous trip and an ignition-on time of a next trip collected from the vehicles.

In an exemplary embodiment of the present disclosure, the processor may be configured to use the charge station usage history information to recommend, as a priority, a charging station which is used most often by the target vehicle among the charging stations near the destination.

In an exemplary embodiment of the present disclosure, the communication device is configured to collect charging station usage history information from the vehicles using the charging station.

An exemplary embodiment of the present disclosure provides a charging station recommending method for an electric vehicle, including collecting, by a processor, vehicle driving information from vehicles, determining, by the processor, an average stay time of the vehicles for each position by using vehicle driving information collected from the vehicles, determining, by the processor, a charging time it takes for a target vehicle to recommend a charging station to reach a destination and charge to a target charging station in response to vehicle information is received from the target vehicle, and recommending, by the processor, one or more of charging stations around the destination as the target vehicle based on the determined charging time and the average stay time for each position.

In an exemplary embodiment of the present disclosure, the vehicle driving information may include destination information and ignition-on/off time information.

In an exemplary embodiment of the present disclosure, the vehicle information may include destination information, SOC (stage of charge) information of the vehicle, and target charging amount information.

In an exemplary embodiment of the present disclosure, the determining of the average stay time of the vehicles for each position may include determining the average stay time for each position using a difference between an ignition-off time of a previous trip and an ignition-on time of a next trip collected from the vehicles.

In an exemplary embodiment of the present disclosure, the determining of the charging time may determining, by the processor, a charging time using a difference between a SOC at the time the target vehicle reaches the destination and a predetermined target charging amount, and a charging speed level of the charging station.

In an exemplary embodiment of the present disclosure, the recommending may include using, by the processor, an average stay time at a destination of the target vehicle among average stay times for each position of the vehicles and the determined charging time, to recommend a charging station suitable for the charging time among charging stations near the destination.

In an exemplary embodiment of the present disclosure, the recommending may include recommending, by the processor, one of the charging stations near the destination by using at least one of the following an average stay time of the vehicles at each position, a charging time required to charge the target vehicle to the target charging amount, charging station information received from charging stations, charging station preference information, charging station usage history information, or a combination thereof.

In an exemplary embodiment of the present disclosure, the recommending may include using, by the processor, the charge station usage history information, to recommend, as a priority, a charging station which is used most often by the target vehicle among the charging stations near the destination.

In an exemplary embodiment of the present disclosure, the method may further include determining, by the processor, that it is the target vehicle in response to a case where a SOC at a time the vehicle arrives at the destination is smaller than a predetermined reference value.

According to the present disclosure, it may be possible to increase user convenience by recommending a charging station that suits a situation of a user among charging stations near a destination based on an average time the vehicle stays for each point of interest (POI) of surrounding vehicles and vehicle information of a target vehicle for charging station recommendation.

According to the present disclosure, it may also be possible to collect vehicle driving information (e.g., destination information, ignition on/off information, etc.) from vehicles, to determine an average stay time of vehicles for each POI, and to store and manage them.

Furthermore, various effects which may be directly or indirectly identified through the present specification may be provided.

### BRIEF DESCRIPTION OF THE FIGURES

FIG. 1 illustrates a block diagram showing a configuration of an example charging station recommending apparatus for an electric vehicle.

FIG. 2 illustrates a detailed configuration of an example user processor of a charging station recommending apparatus for an electric vehicle.

FIG. 3 illustrates a data flow diagram for describing an example charging station recommending process for an electric vehicle.

FIG. 4 illustrates a flowchart for describing an example charging station recommending method for an electric vehicle.

FIG. 5 illustrates an example computing system.

### DETAILED DESCRIPTION

Hereinafter, some exemplary embodiments of the present disclosure will be described in detail with reference to exemplary drawings. It should be noted that in adding reference numerals to constituent elements of each drawing, the same constituent elements include the same reference numerals as possible even though they are indicated on different drawings. In describing an exemplary embodiment of the present disclosure, when it is determined that a detailed description of the well-known configuration or function associated with the exemplary embodiment of the present disclosure may obscure the gist of the present disclosure, it will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those which are generally understood by those skilled in the technical field of the disclosure to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

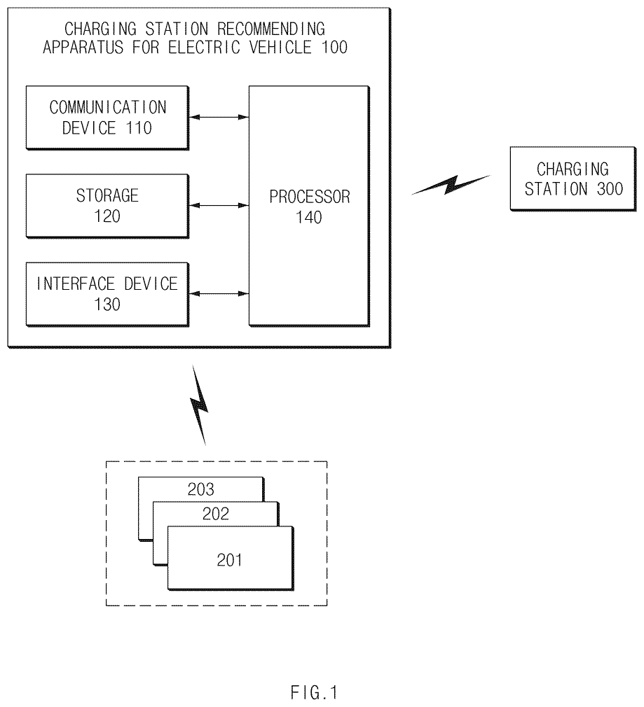

Hereinafter, various exemplary embodiments of the present disclosure will be described in detail with reference to FIG. 1 to FIG. 5.

FIG. 1 illustrates a block diagram showing a configuration of an example charging station recommending apparatus for an electric vehicle.

The electric vehicle of the present disclosure may include an eco-friendly vehicle, i.e., an electric vehicle (EV) that drives wheels using a battery power source, a hybrid electric vehicle (HEV), a plug-in hybrid vehicle (PHEV), and a fuel cell electric vehicle (FCEV), etc. Hereinafter, a vehicle refers to an electric vehicle. A core control device of a battery manager system (BMS) may be installed inside such an electric vehicle. The BMS may be configured to manage driving range prediction, full charging, overcharge prevention, and equal charging algorithms between cells, and may perform a battery replacement notification function through failure management of battery cells or modules and prediction of battery life.

The charging station recommending apparatus 100 for an electric vehicle according to the present disclosure is illustrated in FIG. 1 as an example implemented as a server or system which is separate from the vehicle, but the present disclosure is not limited thereto, and it may be implemented inside the vehicle or separately.

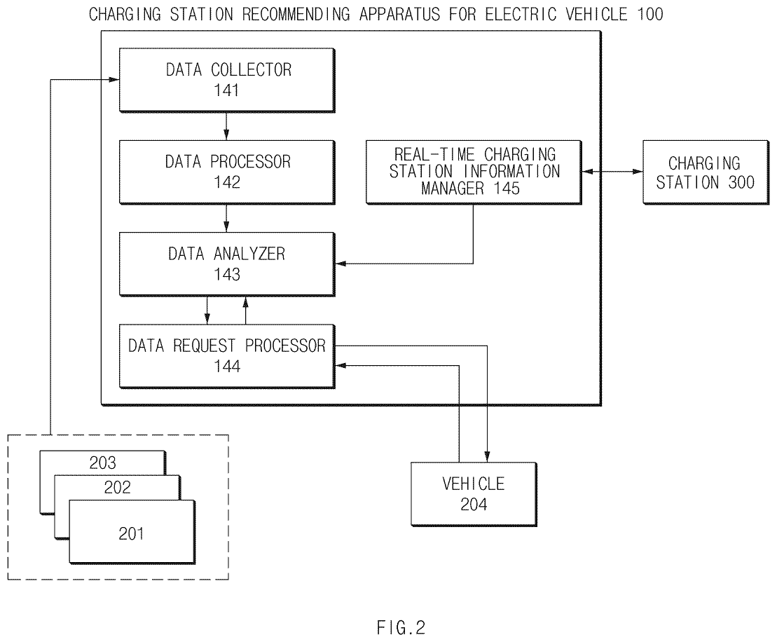

The charging station recommending apparatus 100 may be configured to use vehicle driving information collected from vehicles 201, 202, and 203 to determine an average stay time for each position of the vehicles 201, 202, and 203, and in response to a case where vehicle information is received from a target vehicle (204 in FIG. 2) for recommending an electric vehicle, may be configured to recommend one or more charging stations around a destination to the target vehicle based on a time it takes for the target vehicle to reach the destination and to be charged to a target charging amount and an average stay time for each position.

In the instant case, the position may include a destination and a point of interest (POI). In a general sense, POI (point of interest) refers to a specific location in the real world or on a map or drawing which a specific person is interested in. In the present disclosure, POI may include location information of buildings around a road as destination information such that vehicle users may easily find target points.

Referring to FIG. 1, the charging station recommending apparatus 100 may include a communication device 110, a storage 120, an interface device 130, and a processor 140. According to an exemplary embodiment of the present disclosure, the charging station recommending apparatus 100 may be implemented as a single unit by coupling components with each other, and some components may be omitted.

The communication device 110 is a hardware device implemented with various electronic circuits to transmit and receive signals through a wireless or wired connection, and may communicate with the external vehicles 201, 202, and 203 and a charging station 300 as an exemplary embodiment of the present disclosure.

Furthermore, the communication device 110 may include a mobile communication module, a wireless Internet module, a short-range communication module, etc.

The mobile communication module may be configured to communicate with the external vehicles 201, 202, and 203 and the charging station 300 through a mobile communication network established according to technical standards or communication methods for mobile communication (e.g., global system for mobile communication (GSM), code division multi access (CDMA), code division multi access 2000 (CDMA 2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), 4th generation mobile telecommunication (4G), 5th generation mobile telecommunication (5G).

The wireless Internet module is a module for wireless Internet access, and may communicate with the external vehicles 201, 202, and 203 and the charging station 300 through wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), etc.

The short-range communication module may support short-range communication by using at least one of Bluetooth™, Radio Frequency Identification (RFID), Infrared Data Association (IrDA), ultra wideband (UWB), ZigBee, Near Field Communication (NFC), a Wireless Universal Serial Bus (USB) technique, or any combination thereof.

The communication device 110 may perform V2X communication as an exemplary embodiment of the present disclosure. The V2X communication may include communication between vehicle and all entities such as V2V (vehicle-to-vehicle) communication which refers to communication between vehicles, V2I (vehicle to infrastructure) communication which refers to communication between a vehicle and an eNB or road side unit (RSU), V2P (vehicle-to-pedestrian) communication, which refers to communication between user equipment (UE) held by vehicles and individuals (pedestrians, cyclists, vehicle drivers, or occupants), and V2N (vehicle-to-network) communication.

The storage 120 may store data and/or algorithms required for the processor 140 to operate, and the like.

As an exemplary embodiment of the present disclosure, the storage 120 may store vehicle driving information collected from the vehicles 201, 202, and 203 (e.g., ignition on/off information, destination information, charging station usage history information), and vehicle information received from target vehicles to recommend charging stations (destination information, SOC information, a target charging amount, charging station preference information, charging station history information, etc.).

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the charging station recommending apparatus 100 and results thereof. Herein, the input means may include a key button, and may include a mouse, a joystick, a jog shuttle, a stylus pen, and the like. Furthermore, the input means may include a soft key implemented on the display.

The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In the present disclosure, the output device may output vehicle driving information (e.g., a destination, etc.), vehicle information (e.g., a SOC, etc.), etc.

In the instant case, the display may include at least one of a liquid crystal display (LCD), a thin film transistor liquid crystal display (TFT LCD), an organic light-emitting diode display (OLED display), a flexible display, a field emission display (FED), and a 3D display.

The processor 140 may be electrically connected to the communication device 110, the storage 120, the interface device 130, and the like, may electrically control each component, and may be an electrical circuit that executes software commands, thereby performing various data processing and calculations described below.

The processor 140 may be configured to process signals transmitted between each component of the charging station recommendation apparatus 100 and to perform overall control such that each component may normally perform its function. The processor 140 may be implemented in the form of hardware, software, or a combination of and software. For example, the processor 140 may be implemented as a microprocessor, but the present disclosure is not limited thereto.

The processor 140 may be configured to use vehicle driving information collected from vehicles 201, 202, and 203 to determine an average stay time for each position of the vehicles 201, 202, and 203, and in response to a case where vehicle information is received from a target vehicle (204 in FIG. 2) for recommending an electric vehicle, may be configured to recommend a charging station around a destination to the target vehicle based on a time it takes for the target vehicle to reach the destination and to be charged to a target charging amount and an average stay time for each position.

In the instant case, the vehicle driving information may include destination information, ignition on/off time information, charging station usage history information, etc. Furthermore, the vehicle information may include destination information, vehicle SOC (state of charge) information, target charging amount information, charging station usage history information, charging station preference information, etc.

The processor 140 may be configured to determine a vehicle is a target vehicle to recommend a charging station in response to a case where a SOC (state of charge) at a time the vehicle arrives at the destination is equal to or smaller than a predetermined reference value, and may be configured to determine the vehicle is not the target vehicle to recommend a charging station in response to a case where the SOC (state of charge) at the time the vehicle arrives at the destination is greater than the predetermined reference value.

The processor 140 may be configured to determine the charging time by using the SOC at the time the target vehicle reaches its destination, and a difference value of a predetermined target charging amount and a charging speed level of the charging station (e.g. ultra-fast 200 kW, rapid 100 kW, etc.).

The processor 140 may be configured to recommend a charging station suitable for charging time among charging stations near the destination by using an average time the target vehicle stays at the destination and the determined charging time among average stay times of the vehicles for each position (average stay time for each POI).

The processor 140 can be configured to recommend one of the charging stations near the destination by using at least one of the following: an average stay time of the vehicles at each position, a charging time required to charge the target vehicle to the target charging amount, charging station information received from charging stations, charging station preference information, charging station usage history information, or a combination thereof.

The processor 140 may determine the average stay time for each position by using the difference between an ignition off time of a previous trip collected from vehicles and an ignition on time of a next trip.

The processor 140 may be configured to recommend, as a priority, a charging station which is used most often by the target vehicle among the charging stations near the destination by using the charging station usage history information.

FIG. 2 illustrates a detailed configuration of an example user processor of a charging station recommending apparatus for an electric vehicle.

Referring to FIG. 2, the processor 140 of the charging station recommendation apparatus 100 may include a data collector 141, a data processor 142, a data analyzer 143, a data request processor 144, and a real-time charging station information manager 145.

The data collector 141 may be configured to collect vehicle driving information (e.g., destination information, ignition on/off information, etc.) from the vehicles 201, 202, and 203. Furthermore, the data collector 141 may be configured to collect charging history information from the vehicles 201, 202, and 203. In the instant case, the vehicles 201, 202, and 203 may include all surrounding electric vehicles.

The data processor 142 may be configured to process vehicle driving information collected by the data collector 141. That is, the data processor 142 may be configured to determine, store, and manage an average time which vehicles stayed for each POI by using ignition on/off information and destination information among vehicle driving information. An average time the vehicles 201, 202, and 203 stay at each position, that is, POI, may be determined and stored.

The data analyzer 143 may be configured to determine a recommended charging station among nearby charging stations where vehicles may be charged during their stay by using an average time which vehicles stay at each POI, a current SOC of the vehicle, target charging amount information, and nearby charging station information, etc.

The data request processor 144 may be configured receive vehicle information (e.g., destination information, current SOC of the vehicle, target charging amount information) from the vehicle 204 which is a target vehicle to recommend a charging station, and to transmit it to the data analyzer 143. Accordingly, the data analyzer 143 may be configured to determine a recommended charging station among nearby charging stations where vehicles may be charged during their stay by using an average time which vehicles stay at each POI, a current SOC of the vehicle, target charging amount information, and nearby charging station information, etc., to transmit the determined recommended charging station to the data request processor 144.

Accordingly, the data request processor 144 may be configured to transmit the determined recommended charging station to the vehicle 204 which requested charging station recommendation.

The real-time charging station information manager 145 may be configured to receive and manage charging station information in real time, and to provide real-time charging station information to the data analyzer 143. In the instant case, the real-time charging station information may include information such as whether a charger (charging spot) capable of charging at a charging station exists, a type of charger, and a charging speed.

The data collector 141, the data request processor 144, and the real-time charging station information manager 145 of FIG. 2 may have a same configuration as that of the communication device 110 of FIG. 1.

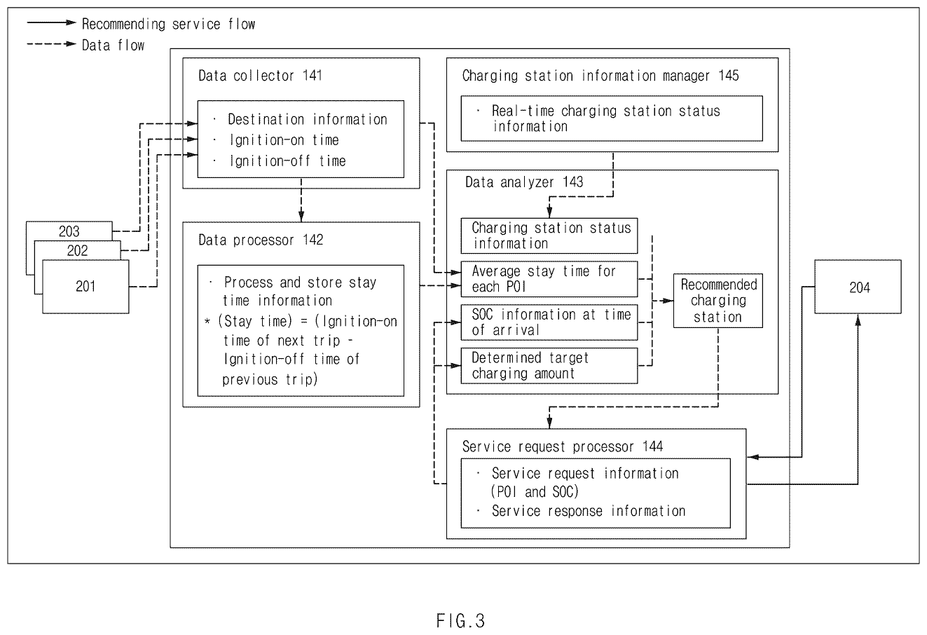

FIG. 3 illustrates a data flow diagram for describing an example charging station recommending process for an electric vehicle.

Referring to FIG. 3, the data collector 141 may be configured to collect vehicle driving information such as destination information, ignition-on/off time information, and charging station usage history from the vehicles 201, 202, and 203.

The data processor 142 may be configured to determine and store the average stay time for each POI by receiving destination information and ignition-on/off time information from the data collector 141.

Stay time=next trip ignition-on time−previous trip ignition-off time Equation 1:

The next trip ignition-on time may indicate one hour of ignition-on during a next drive, and the previous trip ignition-off time may indicate a time the ignition was turned off during a previous drive.

The stay time may indicate the time from the time the ignition was turned off during the previous drive to the time the ignition was turned on during the next drive. Equation 1 may be determined for each POI, and furthermore, the data processor 142 may be configured to determine an average stay time for each POI, which is an average value of the stay time for each POI.

That is, an average time may be determined for stay times of the POIs of the vehicles 201, 202, and 203. For example, in a case where the vehicle 201 stays at a restaurant A for 50 minutes, the vehicle 202 stays at the restaurant A for 40 minutes, and the vehicle 203 stays at the restaurant A for 30 minutes, an average stay time at the restaurant A is 30 minutes.

The data analyzer 143 may be configured to receive destination information, ignition-on/off time information, charging station usage history information, etc. collected by the data collector 141.

The data analyzer 143 may be configured to receive real-time charging station status information from the charging station information manager 145.

The data analyzer 143 may be configured to receive average stay time information for each POI from the data processor 142.

The data analyzer 143 may be configured to receive vehicle information (destination information, vehicle SOC information, a target charging amount, charging station preference information, charging station usage history information, etc.) of the target vehicle 204 to recommend a charging station from the data request processor 144. In the instant case, the vehicle SOC information may include SOC information at a time the target vehicle 204 arrives at the destination. The target charging amount may refer to a charge amount set for driving the target vehicle 204.

The data analyzer 143 may be configured to determine a recommended charging station among surrounding charging stations by using charging station status information, an average stay time for each POI, SOC information at a time of arrival, a target charging amount, etc., and to transmit recommended charging station information to the data request processor 144.

The data analyzer 143 may be configured to determine the charging time required to reach a target charging amount by using SOC information and a target charging amount at a time the target vehicle 204 arrives at the destination. The data analyzer 143 may be configured to recommend a charging station in consideration with a charging time and an average stay time for each POI. For example, in a case where the average stay time at the restaurant A is 30 minutes, the SOC at the time the vehicle 204 arrives at the restaurant A is 20%, and the determined target charge amount is 80%, it may be charged to 60% to reach the target charging amount (80%). In a case where it takes 30 minutes to perform fast charging by 60% of the SOC, the data analyzer 143 may recommend a charging station capable of fast charging among charging stations around the restaurant A. However, in a case where it takes longer to perform quick charging to 60% of the SOC than the average stay time at the restaurant A, a fine may be imposed. That is, in a case where a time it takes to perform fast charging by 60% of the SOC is 30 minutes, the data analyzer 143 may recommend a charging station capable of fast charging among charging stations around the restaurant A. However, for example, in a case where a fine is imposed for more than 1 hour after completion of charging, cases where the average stay time at the restaurant A takes more than one hour longer than a time required to perform fast charging by 60% of the above SOC may be excluded.

For example, in a case where the average stay time at the restaurant A is 100 minutes and the time required to perform fast charging by 60% of the above SOC is 30 minutes, the target vehicle 204 may be parked at a charging position for more than one hour even after charging is completed, a fine may be imposed, and in the instant case, a charging station that takes longer to charge is recommended, so a parking time after charging is completed is less than one hour, so the fine may be avoided. For example, a charging station that takes longer to charge may have a slower charging speed.

The data analyzer 143 may be configured to select a charging station by determining a type of charger at the charging station, whether a charger capable of charging exists, and whether it is fast charging or slow charging. That is, the data analyzer 143 can be configured to select a charging station that matches a charger type of the target vehicle 204, and to select the charging station by determining a charging speed according to the charging time. For example, in a case where the target vehicle 204 stays at a POI for 30 minutes, the analyzer 143 may be configured to select a charging station which may charge at a slow speed in response to a case where a time it takes to slowly charge it to the target charging amount is 30 minutes, and a time it takes to rapidly charge it to the target charge amount is 10 minutes.

Furthermore, the data analyzer 143 may be configured to determine a preferred charging station using the charging station usage history information of the target vehicle 204 and to consider this for selecting the charging station. In the instant case, the charging station usage history information may be obtained by transmitting charging history information to the data collector 141 after the target vehicle 204 is fully charged each time the target vehicle 204 is charged. Furthermore, the charging station usage history information may be transmitted to the datarequest processor 144 in response to the target vehicle 204 enters a destination, and charging station preference information may be directly inputted by a user and transmitted to the data request processor 144. For example, in a case where the user of the target vehicle 204 used a charging station A 10 times and used a charging station B 5 times, the data analyzer 143 may be preferentially configured to recommend the charging station A, which is used more frequently.

Accordingly, the data request processor 144 may be configured to transmit recommended charging station information to the target vehicle 204 to recommend a charging station.

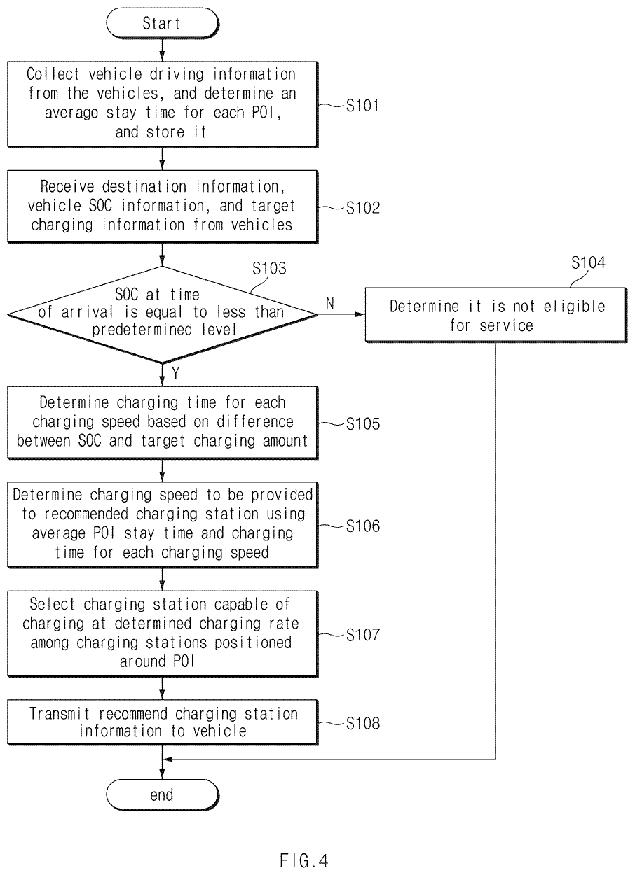

Hereinafter, a charging station recommending method for an electric vehicle according to an exemplary embodiment of the present disclosure will be described with reference to FIG. 4. FIG. 4 illustrates a flowchart for describing an example charging station recommending method for an electric vehicle.

Hereinafter, it is assumed that the charging station recommending apparatus 100 of FIG. 1 performs processes of FIG. 4. In addition, in the description of FIG. 4, operations described as being performed by a device may be understood as being controlled by the processor 140 of the charging station recommending apparatus 100. In following exemplary embodiments, operations of steps S101 to S108 may be performed sequentially, but are not necessarily performed sequentially. For example, an order of each operation may be changed, and at least two operations may be performed in parallel.

Referring to FIG. 4, the charging station recommending apparatus 100 may be configured to collect vehicle driving information from the vehicles 201, 202, and 203, and to determine an average stay time for each POI, and store it (S101). In the instant case, the charging station recommending apparatus 100 may be configured to collect vehicle driving information at predetermined intervals and determine the average stay time for each POI, and may be configured to collect vehicle driving information each time the vehicles 201, 202, and 203 arrive at a POI to determine the average stay time for each POI.

In the instant case, the charging station recommending apparatus 100 may be configured to collect destination information and ignition-on/off time from the vehicle, and to determine and manage a time a user stays at a destination. That is, the charging station recommending apparatus 100 may be configured to determine a time the target vehicle 204 stays at the position (destination) using a difference between a time at which ignition is turned off and a time at which the ignition is turned on.

In response to a case where a destination is set by a user, the target vehicle 204 may be configured to transmit destination information, vehicle SOC information (a current SOC, a SOC at a time the vehicle reaches the destination, etc.), and target charging amount information to the charging station recommending apparatus 100 (S102).

The charging station recommending apparatus 100 may be configured to determine whether the SOC at the time the target vehicle 204 arrives at the destination is smaller than or equal to a predetermined reference value (a certain level) (S103).

In response to a case where the SOC at the time the target vehicle 204 arrives at the destination is greater than the predetermined reference value, the charging station recommending apparatus 100 may be configured to determine that the target vehicle 204 may not require charging and is not eligible for service, and to terminate the operation (S104).

On the other hand, in response to a case where the SOC at the time the target vehicle 204 arrives at the destination is smaller than the predetermined reference value, the charging station recommending apparatus 100 may be configured to determine that the vehicle requires charging, to determine that a difference between the SOC and the target charging amount at the time the target vehicle 204 arrives at the destination, and to determine a charging time for each charging speed based on the difference between the SOC and the target charging amount at the time the vehicle arrives at the destination and a charging speed level of the charging station (e.g., ultra-fast 200 kW, rapid 100 kW, etc.) (S105). For example, in a case where the SOC at the time the vehicle arrives at the destination is 40% and the target charging amount is 80%, a difference therebetween is 40%. Accordingly, 40% charging is required to reach the target charging amount, and in response to slow charging, charging time may take 3 hours, and in response to fast charging, charging time may take 20 minutes.

Thus, the charging station recommendation apparatus 100 may be configured to determine the charging speed to be provided as a recommended charging station using charging time information for each charging speed (S106). That is, the charging station recommendation apparatus 100 may be configured to determine whether the charging speed will be slow or rapid according to the difference between the SOC and the target charging amount at the time the target vehicle 204 arrives at the destination.

The charging station recommending apparatus 100 may be configured to select a charging station capable of charging at the determined charging rate among charging stations positioned around the POI (S107).

Accordingly, the charging station recommendation apparatus 100 may be configured to notify the vehicle of the selected charging station as a recommended charging station (S108).

For example, in a case where a user of the vehicle 204 sets a restaurant A as the destination and the SOC at the time of arrival at the restaurant A is 10% and the target charging amount is 80%, the charging station recommending apparatus 100 may be configured to recommend a charging station which is positioned near restaurant A (destination) and capable of rapidly charging the target vehicle 204 in response to a case where fast charging takes 30 minutes to reach the target charging amount, and an average time other vehicles stays at the restaurant A is 40 minutes. Accordingly, the target vehicle 204 may perform route guidance by setting the recommended charging station as the destination.

Accordingly, the charging station recommending apparatus 100 of the present disclosure may be configured to determine and store an average stay time for each POI using driving information of vehicles. In the instant case, the charging station recommending apparatus 100 may be configured to collect driving information of vehicles at predetermined intervals and to determine the average stay time for each POI at each predetermined interval. Furthermore, the charging station recommending apparatus 100 may be configured to determine and store the average stay time of the POI whenever vehicles stay at the POI.

Thereafter, in response to a case where vehicle information (destination information, vehicle SOC information, a target charging amount) is received from a specific vehicle, the charging station recommending apparatus 100 may be configured to recommend an optimal charging station suitable for a situation of the user by using the average stay time for each POI stored in advance and vehicle information (the destination information, the vehicle SOC information, the target charging amount) received from the vehicle recommended for charging stations, to recommend a charging station to the specific vehicle.

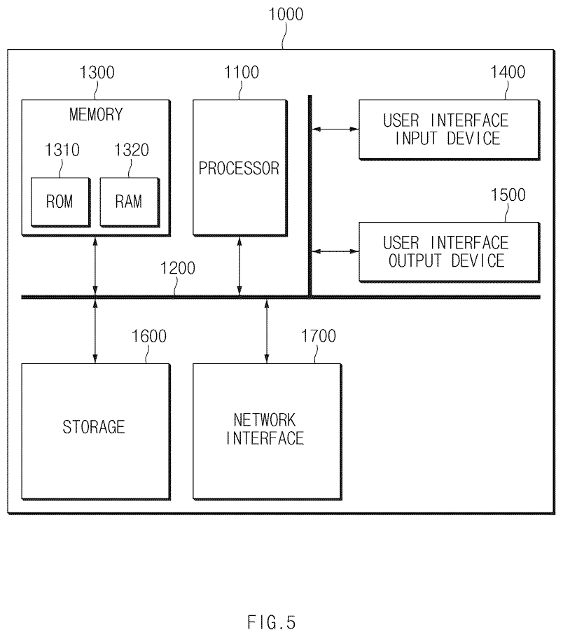

FIG. 5 illustrates an example computing system.

Referring to FIG. 5, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that is configured to perform processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

1. A charging station recommending apparatus for an electric vehicle, the apparatus comprising:
a communication device configured to communicate with a plurality of vehicles and a plurality of charging stations; and
a processor configured to determine an average stay time for each position of each of the plurality of vehicles by using vehicle driving information collected from the plurality of vehicles, and in response to a case where vehicle information is received from a target vehicle to recommend a charging station, the processor is configured to recommend a charging station located around a destination to the target vehicle based on a time it takes for the target vehicle to reach the destination, to charge to a target charging amount, and the average stay time for each position.

2. The charging station recommending apparatus of claim 1, wherein the vehicle driving information includes destination information and ignition-on/off time information.

3. The charging station recommending apparatus of claim 1, wherein the vehicle information includes destination information, state of charge (SOC) information of the vehicle, and target charging amount information.

4. The charging station recommending apparatus of claim 3, wherein the vehicle information further includes charging station usage history information of the vehicle, or charging station preference information of a user of the vehicle.

5. The charging station recommending apparatus of claim 1, wherein the processor is further configured to determine that it is the target vehicle in response to a case where a state of charge (SOC) at a time the vehicle arrives at the destination is smaller than a predetermined reference value.

6. The charging station recommending apparatus of claim 1, wherein the processor is further configured to determine a charging time using a difference between a state of charge (SOC) at the time the target vehicle reaches the destination and a predetermined target charging amount, and a charging speed level of the charging station.

7. The charging station recommending apparatus of claim 6, wherein the processor is further configured to:
use an average stay time at a destination of the target vehicle among average stay times for each position of each of the plurality of vehicles and the determined charging time; and
recommend a charging station suitable for the charging time among charging stations near the destination.

8. The charging station recommending apparatus of claim 1, wherein the processor is configured to recommend one of the plurality of charging stations located around the destination by using at least one of: an average stay time of the plurality of vehicles at each position, a charging time required to charge the target vehicle to the target charging amount, charging station information received from the plurality of charging stations, charging station preference information, charging station usage history information, or a combination thereof.

9. The charging station recommending apparatus of claim 1, wherein the processor is further configured to determine the average stay time for each position using a difference between an ignition-off time of a previous trip and an ignition-on time of a next trip collected from the plurality of vehicles.

10. The charging station recommending apparatus of claim 4, wherein the processor is further configured to:
use the charge station usage history information; and
recommend, as a priority, a charging station which is used most often by the target vehicle among the charging stations located around the destination.

11. The charging station recommending apparatus of claim 1, wherein the communication device is configured to collect charging station usage history information from the plurality of vehicles using the charging station.

12. A method for recommending a charging station for an electric vehicle, the method comprising:
collecting, by a processor, vehicle driving information from a plurality of vehicles;
determining, by the processor, an average stay time of the plurality of vehicles for each position by using vehicle driving information collected from the plurality of vehicles;
determining, by the processor, a charging time it takes for a target vehicle to recommend a charging station to reach a destination and charge to a target charging station in response to vehicle information received from the target vehicle; and
recommending, by the processor, one or more charging stations located around the destination as the target vehicle based on the determined charging time and the average stay time for each position.

13. The charging station recommending method of claim 12, wherein the vehicle driving information includes destination information and ignition-on/off time information.

14. The charging station recommending method of claim 12, wherein the vehicle information includes destination information, state of charge (SOC) information of the vehicle, and target charging amount information.

15. The charging station recommending method of claim 12, wherein the determining of the average stay time of the plurality of vehicles for each position includes determining, by the processor, the average stay time for each position using a difference between an ignition-off time of a previous trip and an ignition-on time of a next trip collected from the plurality of vehicles.

16. The charging station recommending method of claim 12, wherein the determining of the charging time includes determining, by the processor, a charging time using a difference between a state of charge (SOC) at the time the target vehicle reaches the destination and a predetermined target charging amount, and a charging speed level of the charging station.

17. The charging station recommending method of claim 16, wherein the recommending includes using, by the processor, an average stay time at a destination of the target vehicle among average stay times for each position of the plurality of vehicles and the determined charging time, to recommend a charging station suitable for the charging time among the one or more charging stations located around the destination.

18. The charging station recommending method of claim 12, wherein the recommending includes recommending, by the processor, one of the charging stations located around the destination by using at least one of: an average stay time of the plurality of vehicles at each position, a charging time required to charge the target vehicle to the target charging amount, charging station information received from the one or more charging stations, charging station preference information, charging station usage history information, or a combination thereof.

19. The charging station recommending method of claim 18, wherein the recommending further includes using, by the processor, the charge station usage history information to recommend, as a priority, a charging station used most often by the target vehicle among the one or more charging stations located around the destination.

20. The charging station recommending method of claim 12, further comprising determining, by the processor, that it is the target vehicle in response to a case where a state of charge (SOC) at a time the vehicle arrives at the destination is smaller than a predetermined reference value.
